(19) United States
(12) Patent Application Publication
(10) Pub. No.: US 2004/0179706 A1
(43) Pub. Date: Sep. 16, 2004

(54) Microphone devices

(76) Inventor: Gerard van Oerle, Uster (CH)

Correspondence Address: PEARNE & GORDON LLP, 1801 EAST 9TH STREET, SUITE 1200, CLEVELAND, OH, 44114-3108, US

(21) Appl. No.: 10/386,305

(22) Filed: Mar. 11, 2003

(51) Int. Cl. H04R 25/00; H04R 9/08; H04R 11/04; H04R 17/02; H04R 19/04; H04R 21/02

(52) U.S. Cl. 381/312; 381/369; 381/322; 381/324

(57) ABSTRACT

A microphone device sized for use in a hearing device. The microphone device includes a buffer stage with an output FET. The microphone device has exclusively a reference potential tap and an output signal tap.

The present invention is generically directed on microphone devices sized for hearing device implementation, microphone arrangements sized for hearing device implementation as well as to a method for biasing a FET buffer output stage of a microphone device.

Thereby, the present invention departs from problems which have been recognized in context with capacitive microphones, whereat a capacitive element provides for acoustical/electrical conversion. Such capacitive element which performs conversion of mechanical movement of at least one of the capacitor plates into a respective electric signal necessitates a buffer stage to tap off the resulting electric signal, which buffer must only consume very little input current. Therefore, it is customary to provide such a buffer stage with at least one FET.

More generalizing, such a buffer stage will be used wherever in such microphone device the acoustical/electrical converting element may not be loaded by a relatively heavy current.

It is further customary to integrate the buffer stage together with the acoustical/electrical conversion element into one unitary microphone device.

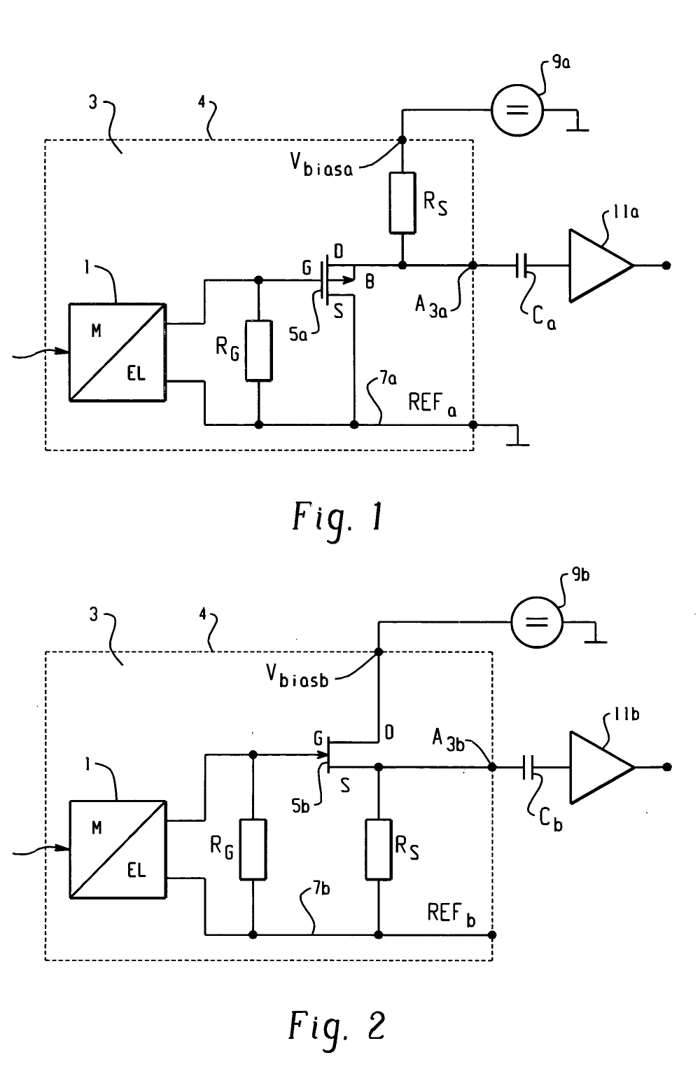

In FIG. 1 a known microphone device 4 is schematically shown. It comprises a mechanical/electrical conversion element 1, which may customarily be realized by a capacitance element with a mechanically moveable or swingable capacitance plate as mentioned above. The electric output signal of such conversion unit 1 is fed to a buffer stage 3, namely on one hand to the gate of a Mos-FET 5ₐ and on the other hand to reference potential line 7ₐ connected to the source electrode S of the Mos-FET 5ₐ. The drain electrode D of the Mos-FET 5, is on one hand operationally connected via a resistance element R_{S} to a biasing input tap V_{biasa} and on the other hand to the signal output of the device, A₃ₐ. The Bulk of the Mos-FET is denoted with B in FIG. 1. The gate electrode G of the Mos-FET 5ₐ is operationally connected either via a resistance element R_{G} or via another device acting as resistive element to the reference potential line 7ₐ.

According to FIG. 2 in a further known device 4 the mechanical/electrical conversion unit 1 has an output which on one hand is operationally connected to the gate electrode G of a JFET element 5_{b}, the drain electrode D thereof is operationally connected to a bias tap V_{biasb} of the device 4. The source electrode S of the JFET 5_{b} is connected to an output tap A_{3b} of the device 4 and connected via a resistance element R₅ to the reference potential line 7_{b}. The gate G of the JFET 5_{b} is operationally connected to the reference potential line 7_{b} by a resistance element R_{G}.

Customarily the bias tap V_{biasa} according to FIG. 1 or V_{biasb} according to FIG. 2 is connected to respective voltage sources, as biasing voltage sources, 9a or 9b respectively. The respective outputs A₃ₐ and A_{3b} are operationally connected via a coupling capacitor Cₐ, C_{b} respectively to respective preamplifiers 11ₐ and 11_{b}. The bias voltage sources 9_{a,b} as well as coupling capacitors C and preamplifiers 11 are thereby customarily mounted on a circuit board, or integrated on an integrated circuit, separate from the microphone 4 with the buffer stage 3 having the respective output FET 5a and 5b with the additional resistance elements.

Definition

We understand under a voltage source a source which delivers a voltage substantially independent of the output current.

We understand as a current source a source which delivers a constant current substantially independent of the output voltage.

The voltage applied to the respective biasing inputs V_{biasa} and V_{biasb} must be extremely clean, i.e. on one hand clean of noise and on the other hand very stable, Therefore, very high requirements have to be fulfilled with respect to noise level reduction as well as with respect to stabilizing the applied voltage with respect to variations of power supply voltage. E.g. for the power supply rejection ratio PSRR 60 to 80 dB rejection is required customarily.

Disturbances of the biasing voltage are transmitted without significant attenuation to the output of the microphone device, i.e. A₃ₐ, A_{3b}. In practice especially an output loudspeaker of a hearing device will cause modulation of the power supply, i.e. the battery voltage, which modulation will be perceivable in the electric audio signal it the voltage applied to V_{biasa,b} provides for a too low PSSR.

For attempting low power appliances the very high requirements to the PSRR is a serious problem. It would clearly be a need to exploit newer up-to-date IC technologies with low threshold voltages by operating the overall analog network of a hearing device without DC/DC converter electrically supplied directly from a power supply battery. Thereby, one would gain different advantages, namely

1 with respect to efficiency

2. with respect to less external components (no DC/DC converter)

3. with respect to power consumption. E.g. an analog to digital converter consuming 150 μA current consumes considerably more power from a 1.8 V power supply than from a 1.3 V supply.

One serious problem to be resolves when attempts are made to operate the analog circuitry as applied to a hearing device directly from the power supply, namely a battery or an accumulator battery, is that a high PSRR with respect to the voltage applied to V_{bias} is only very difficult to realize.

This problem is especially pronounced if the solution thereof should not imply the use of additional electronic components.

It is an object of the present invention to solve this problem. This is realized by a method for biasing a FET output buffer stage of a microphone device sized for hearing device implementation, wherein biasing comprises applying a substantially constant voltage-independent current. Thereby, it has been recognized and exploited that the influence of power supply voltage variation may be significantly easier attenuated with respect to the current of a current source than this is possible with respect to the voltage of a voltage source.

In a preferred embodiment wherein the output stage comprises a Mos-FET output stage the voltage-independent current is preferably applied to the drain electrode of the Mos-FET. In the case where the output stage comprises an output JFET, the voltage-independent current is preferably applied to the source electrode of the JFET.

Realization of this method according to the present invention, namely of biasing a FET output buffer stage of such a device further significantly simplifies construction of such device:

There is realized a microphone device according to the present invention, which comprises a buffer stage with an output FET. The device has exclusively a reference potential tap and an output signal tap. Having only two taps such microphone device e.g. significantly reduces the efforts to be electrically connected to the downstream network and thereby e.g. the known problems of establishing clean, optimally conductive connections by automation.

Thereby this microphone device with only two output taps is especially preferably realized with the output FET being a Mos-FET. In a preferred mode such device has a capacitance as an acoustical/electrical converter element.

On the other hand by the concept according to the present invention it is possible to realize according to the present invention a microphone device, again sized for hearing device implementation, which comprises a buffer stage with an output FET and wherein the device comprises an output signal tap from an electrode of the output FET, which output is not shunted, e.g. by a resistance, to a further tap of the device. Especially when providing the output FET as a JFET there is thereby reduced the number of electronic elements within the device at least by one resistance, which is normally provided between the source electrode output and reference potential line.

Again in a preferred embodiment this microphone device too comprises a capacitance as an acoustical/electrical converter element.

According to the present invention there is further provided a microphone arrangement sized for hearing device implementation, which comprises an output buffer stage of a microphone unit, which stage having an output FET, one electrode thereof being operationally connected to the input of a preamplifier and wherein there is present a current source operationally connected to the said electrode of the output FET. In a first most preferred embodiment the FET is a Mos-FET and the electrode is the drain electrode.

In a further preferred embodiment of this arrangement the FET is a JFET, and the said electrode is the source electrode. Thereby, still applying a JFET, the current source is preferably operationally connected between the source electrode and a reference potential of the arrangement. Thereby further preferred, the source electrode is not additionally connected by a resistive branch to the reference potential line.

On the other hand, looking back on the first preferred embodiment, wherein the FET is a Mos-FET, then the current source is preferably operationally connected to the drain electrode, which is preferably not operationally connected to any further biasing source.

The present invention is further directed on a hearing device which comprises at least one microphone device as outlined above or which comprises at least one microphone arrangement as discussed above.

The invention shall now be exemplified with the help of figures.

These figures show:

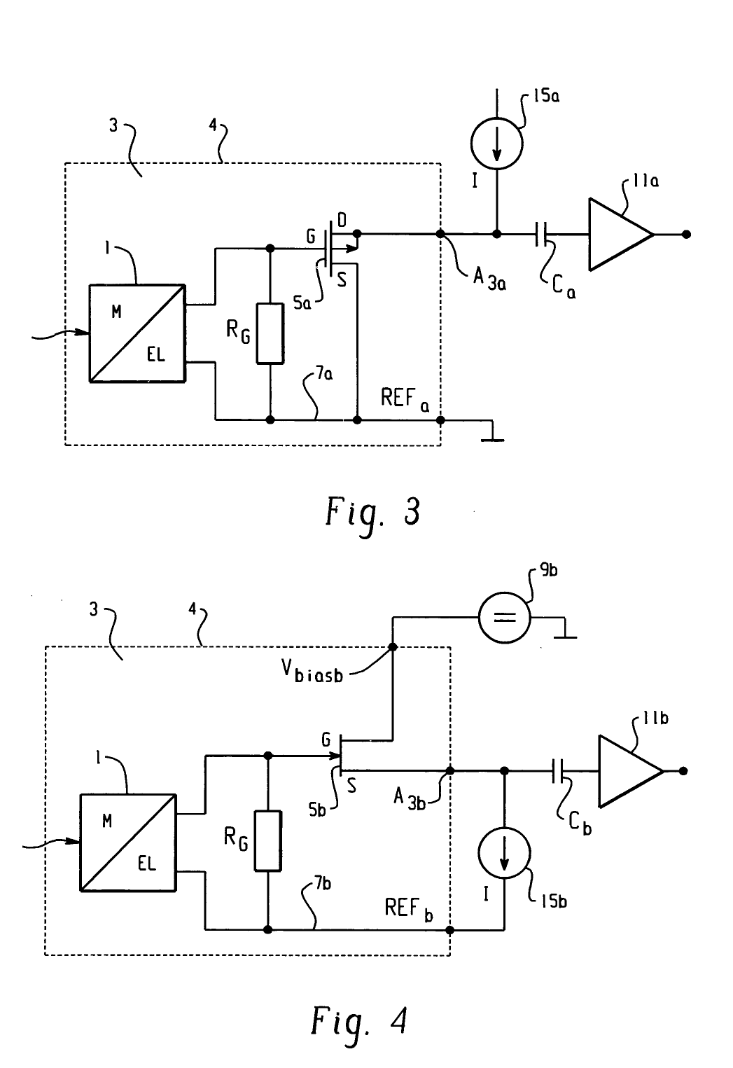

FIG. 3 a microphone device as a part of a microphone arrangement according to the present invention and performing the method according to the present invention, shown as an inventive improvement Over a prior art embodiment as shown in FIG. 1;

FIG. 4 a further preferred embodiment of a device, part of an arrangement and operating the method according to the present invention and shown as an improvement over the prior art embodiment as shown in FIG. 2.

In FIG. 3 as departing from a known prior art embodiment as of FIG. 1, the same elements which have already been described in context with FIG. 1 are not described anymore and are referred to with the same reference numbers.

According to this embodiment of the present invention a constant current source 15ₐ is applied to the drain electrode of Mos-FET 5ₐ and via coupling capacitor Ca, is operationally connected to the preamplifier 11a. The current source 15a may thereby possibly be implemented within the microphone device 4 or, as shown in FIG. 3, within the circuitry downstream of such device 4. Thereby the biasing input V_{biasa} as of FIG. 1 becomes obsolete and is thereby preferably completely omitted from the device 4, altogether with resistance R_{S} according to FIG. 1. There is thereby provided a microphone device which has only two taps, namely one A₃ₐ for the output signal and possibly for the biasing current I and one for applying reference potential to the circuitry.

In FIG. 4 those elements which have already been described in context with FIG. 2 need not to be described once again and are referred to with the same reference numbers. According to FIG. 4 there is provided a constant current sink-source 15b between the source electrode S of the JFET 5b and the reference potential line 7_{b} Thereby the source resistance element R_{S} according to FIG. 2 is removed so that the source electrode S of JFET 5_{b} is not connected or shunted by such resistance element to the reference potential line 7_{b}.

Due to the fact that according to the present invention biasing at least comprises providing such biasing by means of a constant current or constant current source, the output signal of the microphone device as at A₃ becomes much less sensitive to supply voltage variation, because PSSR to the respective current sources 15 is much easier realized than to the customarily applied voltage sources. Even in the embodiment according to FIG. 4 where the JFET still needs a biasing voltage to the gate electrode G, C) provision of the constant current source 15_{b} significantly reduces PSSR problems. Additionally according to the invention, microphone devices are thereby realized with fewer electronic elements and additionally even with fewer taps. This significantly facilitates manufacturing and assembling of respective hearing devices with such microphone devices or arrangements.

1. A microphone device sized for a hearing device implementation comprising a buffer stage with an output FET, said device having exclusively a reference potential tap and an output signal tap.

2. The device of claim 1, wherein said output FET is a Mos-FET.

3. The device of claim 1 having a capacitance as an acoustical/electrical converter element.

4. A microphone device sized for hearing device implementation, comprising a buffer stage with an output FET, said device comprising an output signal tap from an electrode of said output FET, said output not having a dc path via another built-in component to a further tap of said device.

5. The device of claim 4, wherein said FET is a JFET.

6. The device of claim 4 having a capacitance as acoustical/electrical converter element.

7. A microphone arrangement sized for hearing device implementation, comprising an output buffer stage of a microphone stage with an output FET, one electrode thereof being operationally connected to the input of a preamplifier, a current source operationally connected to said input and said output.

8. The arrangement of claim 7, wherein said FET is a Mos-FET and said electrode is the drain electrode.

9. The arrangement of claim 7, wherein said FET is a JFET and said electrode is a source electrode.

10. The arrangement of claim 9, wherein said current source is operationally connected between said source electrode and a reference potential line of said arrangement.

11. The arrangement of claim 10, wherein said drain electrode is not connected by a resistive branch to said ground potential line.

12. The arrangement of claim 7, wherein said FET is a Mos-FET, said current source is operationally connected to the drain electrode and said drain electrode not being operationally connected to a further biasing source.

13. The arrangement of claim 12, wherein said current source is operationally connected to said drain electrode.

14. A method for biasing a FET output buffer stage of a microphone device sized for hearing device implementation, wherein said biasing comprises the step of applying a substantially constant supply-voltage-independent current.

15. The method of claim 14, wherein said output stage comprises a Mos-FET output stage, further comprising the step of applying said current to the drain electrode of said Mos-FET.

16. The method of claim 11, wherein said buffer output stage comprises an output JFET, further comprising the step of applying said constant current to the source electrode of said JFET.

17. A hearing device comprising a microphone device according to one of the claims 1 to 6.

18. A hearing device with at least one microphone arrangement according to one of the claims 7 to 13.
